(19) United States
(12) Patent Application Publication
(10) Pub. No.: US 2012/0300034 A1
(43) Pub. Date: Nov. 29, 2012

(54) INTERACTIVE USER INTERFACE FOR STEREOSCOPIC EFFECT ADJUSTMENT

(75) Inventors: Kalin Atanassov, San Diego, CA (US); Sergiu R. Goma, San Diego, CA (US); Joseph Cheung, San Diego, CA (US); Vikas Ramachandra, San Diego, CA (US)

(73) Assignee: QUALCOMM INCORPORATED, San Diego, CA (US)

(21) Appl. No.: 13/218,379

(22) Filed: Aug. 25, 2011

Related U.S. Application Data
(60) Provisional application No. 61/489,224, filed on May 23, 2011.

(51) Int. Cl. H04N 13/02; G06T 15/00

(52) U.S. Cl. 348/46; 345/419; 348/E13.074

(57) ABSTRACT

Present embodiments contemplate systems, apparatus, and methods to determine a user's preference for depicting a stereoscopic effect. Particularly, certain of the embodiments contemplate receiving user input while displaying a stereoscopic video sequence. The user's preferences may be determined based upon the input. These preferences may then be applied to future stereoscopic depictions.

### CLAIM OF PRIORITY UNDER 35 U.S.C. §119

This application claims the benefit under 35 U.S.C. Section 119(e) of co-pending and commonly-assigned U.S. Provisional Patent Application Ser. No. 61/489,224, filed on May 23, 2011, by Kalin Atanassov, Sergiu Goma, Joseph Cheung, and Vikas Ramachandra, entitled “INTERACTIVE USER INTERFACE FOR STEREOSCOPIC EFFECT ADJUSTMENT,” which application is incorporated by reference herein.

### TECHNICAL FIELD

The present embodiments relate to calibration of a stereoscopic effect, and in particular, to methods, apparatus and systems for determining user preferences with regard to the stereoscopic effect.

### BACKGROUND

Stereopsis comprises the process by which the human brain interprets an object's depth based upon the relative displacement of the object as seen from the left and right eyes. The stereoscopic effect may be artificially induced by taking first and second images of a scene from first and second laterally offset viewing positions and presenting the images separately to each of the left and right eyes. By capturing a succession of stereoscopic image pairs in time, the image pairs may be successively presented to the eyes to form a “three-dimensional movie.”

As the stereoscopic effect relies upon the user to integrate the left and right images into a single picture, user-specific qualities may affect the experience. Particularly, the disparity between objects in the left and right images will need to be correlated with a particular depth by the user's brain. While stereoscopic projectors and displays are regularly calibrated prior to use, an efficient and accurate means for rapidly determining a specific user's preferences, based on certain factors, for a given stereoscopic depiction remains lacking.

### SUMMARY

Certain embodiments contemplate a method, implemented on an electronic device, for determining a parameter for a stereoscopic effect. The method may comprise displaying to a user a plurality of images comprising a stereoscopic effect of an object, the object depicted at a plurality of three-dimensional locations by the plurality of images; receiving a preference indication from the user of a preferred three-dimensional location; and determining a parameter for stereoscopic depictions of additional images based upon the preference indication.

In certain embodiments, at least two of the plurality of locations may be displaced relative to one another in the x, y, and z directions. In some embodiments, the plurality of locations comprises a location having a positive depth position. In some embodiments, the plurality of images further comprise a stereoscopic effect of a second object, the second object depicted at a second plurality of locations by the plurality of images, the second plurality of locations comprising a location having a negative depth position. In some embodiments, the plurality of images depicts movement of the object in the plane of a display. In some embodiments, the plurality of images may be dynamically generated based on at least a screen geometry of a display. In some embodiments, the plurality of images may be dynamically generated based on at least the user's distance from a display. In some embodiments, the method further comprises storing the parameter to a memory. In some embodiments, the method further comprises determining a maximum range for depth of the object based upon the parameter. In some embodiments, the electronic device comprises a mobile phone. In some embodiments, the parameter is the preference indication.

Certain embodiments contemplate a computer-readable medium comprising instructions that when executed cause a processor to perform various steps. The steps may include: displaying to a user a plurality of images comprising a stereoscopic effect of an object, the object depicted at a plurality of locations by the plurality of images; receiving a preference indication from the user of a preferred three-dimensional location; and determining a parameter for stereoscopic depictions of additional images based upon the preference indication.

In some embodiments, at least two of the plurality of locations are displaced relative to one another in the x, y, and z directions. In some embodiments, the plurality of locations comprises a location having a positive depth position. In some embodiments, the plurality of images further comprise a stereoscopic effect of a second object, the second object depicted at a second plurality of locations by the plurality of images, the second plurality of locations comprising a location having a negative depth position. In some embodiments, the plurality of images depicts movement of the object in the plane of the display.

Certain embodiments contemplate an electronic stereoscopic vision system, comprising: a display; a first module configured to display a plurality of images comprising a stereoscopic effect of an object, the object depicted at a plurality of locations by the plurality of images; an input configured to receive a preference indication from the user of a preferred three-dimensional location; and a memory configured to store a parameter associated with the preference indication, wherein the parameter is used to display additional images according to the preference indication of the user.

In certain embodiments, at least two of the plurality of locations are displaced relative to one another in the x, y, and z directions. In some embodiments, the plurality of locations comprises a location having a positive depth position. In some embodiments, the plurality of images further comprise a stereoscopic effect of a second object, the second object depicted at a second plurality of locations by the plurality of images, the second plurality of locations comprising a location having a negative depth position. In some embodiments, the plurality of images depicts movement of the object in the plane of the display. In some embodiments, the plurality of images is dynamically generated based on at least a screen geometry of the display. In some embodiments, the plurality of images is dynamically generated based on at least the user's distance from the display. In some embodiments, the electronic device comprises a mobile phone. In some embodiments, the parameter is the preference indication.

Certain embodiments contemplate a stereoscopic vision system in an electronic device, the system comprising: means for displaying to a user a plurality of images comprising a stereoscopic effect of an object, the object depicted at a plurality of locations by the plurality of images; means for receiving a preference indication from the user of a preferred three-dimensional location; and means for determining a parameter for stereoscopic depictions of additional images based upon the preference indication.

In some embodiments, the displaying means comprises a display, the depicting means comprises a plurality of images, the means for receiving a preference indication comprises an input, and the means for determining a stereoscopic parameter comprises a software module configured to store a preferred range. In some embodiments, at least two of the plurality of locations are displaced relative to one another in the x, y, and z directions.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 depicts a possible display device for displaying a stereoscopic depiction of an image.

FIGS. 2A and 2B depict various factors contributing to the generation of the stereoscopic effect.

FIGS. 3A and 3B depict various factors contributing to the generation of the stereoscopic effect in relation to the user's position relative to a display.

FIG. 4 depicts certain object motion patterns relative to the display, as may appear in certain of the disclosed embodiments.

FIG. 5 depicts certain user preferences in relation to the possible object motion patterns in certain of the disclosed embodiments.

FIGS. 6A-6D depict certain of the user-preferred ranges for depth in a stereoscopic effect.

FIG. 7 is a flow diagram depicting a particular embodiment of a preference determination algorithm employed by certain of the embodiments.

### DETAILED DESCRIPTION

Embodiments relate to systems for calibrating stereoscopic display systems so that presentation of the stereoscopic video data to a user is perceived as comfortable to the user's eyes. Because different users may have differing tolerances for how they perceive stereoscopic videos, systems and methods described herein allow a user to modify certain stereoscopic display parameters to make viewing the video comfortable to the user. In one embodiment, a user can modify stereoscopic video parameters in real-time as the user is viewing a stereoscopic video. These modifications are then used to display the stereoscopic video to the user in a more comfortable format.

Present embodiments contemplate systems, apparatus, and methods to determine a user preference with regard to the display of stereoscopic images. Particularly, a stereoscopic video sequence is presented to a user in one embodiment. The system takes calibration input from the user wherein the user input may not require a user to possess extensive knowledge of 3D technology. For example, a user may select “less” or “more” of a three-dimensional effect in the video sequence being viewed. The system would input that information and reduce or increase the three-dimensional effect being presented within the video sequence by altering the angular or lateral disparity of the left eye and right eye images presented to the user.

One skilled in the art will recognize that these embodiments may be implemented in hardware, software, firmware, or any combination thereof. The stereoscopic display may be found on a wide range of electronic devices, including mobile wireless communication devices, personal digital assistants (PDAs), laptop computers, desktop computers, televisions, digital cameras, digital recording devices, and the like.

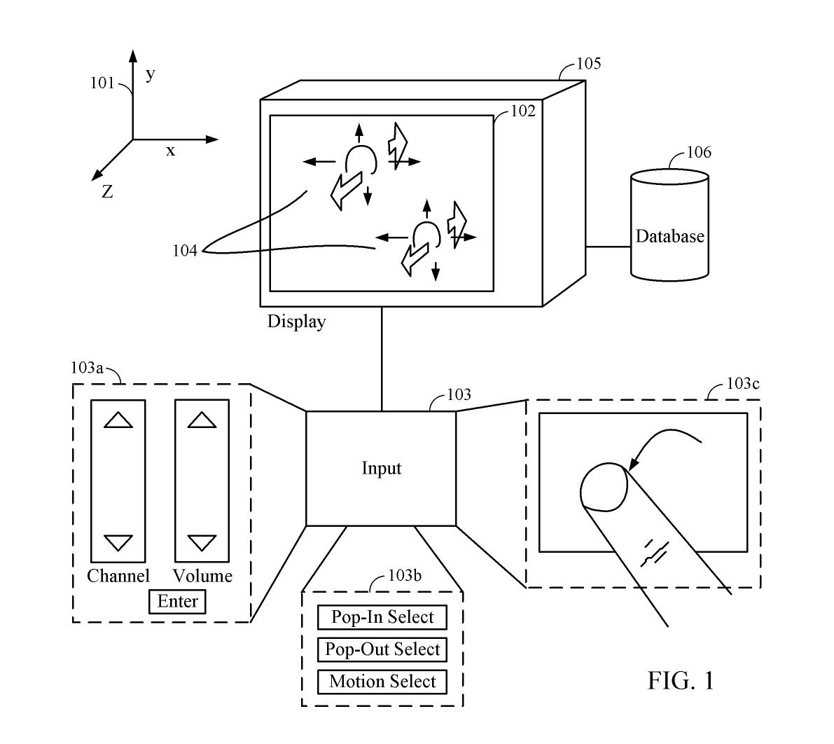

FIG. 1 depicts one possible display device 105 configured to display a stereoscopic depiction of a scene. Display device 105 may comprise a display 102, viewscreen, or other means for displaying to a user, depicting a plurality of objects 104 at a plurality of depths in the z-direction in a scene. In some devices, the scene may comprise a pair of images, a first image for the user's left eye and a second image for the user's right eye. In this example, the two images may be presented at the same time on display 102, but may be emitted from display 102 with different polarizations. A user wearing polarized lenses may then perceive the first image in their left eye and the second image in their right eye (the lenses being correspondingly linearly polarized, circularly polarized, etc.). One will readily recognize a plurality of other methods for delivering separate images to each of the right and left eyes. For example, device 105 may comprise two laterally separated displays 102. By holding device 105 close to the user's face, each laterally offset image may be separately presented to each of the user's eyes. Shutter-lenses and similar technology may also suffice. The present embodiments may be used at least with any system that provides a stereoscopic depiction, regardless of the particular methods by which that depiction is generated.

An input 103, either attached to display device 105, or operating remotely, may be used to provide user input to display device 105. In some embodiments, the input 103 may comprise input controls attached to, or integrated into the housing of, display device 105. In other embodiments, the input 103 may comprise a wireless remote control, such as are used with televisions. Input 103 may be configured to receive key or button presses or motion gestures from the user, or any other means for receiving a preference indication. In some embodiments, buttons on input 103 designated for other purposes, such as for selecting a channel, adjusting the volume, or entering a command, 103a may be repurposed to receive input regarding the calibration procedure. In some embodiments, buttons specifically designed for receiving calibration inputs 103b may be provided. In gesture sensitive inputs 103c, the system may recognize certain gestures on a touchscreen (via a finger, stylus, etc.) during the calibration procedure as being related to calibration. The inputs may be used to control the calibration procedure, as well as to indicate preferred parameters. For example, in some embodiments depressing the channel selection button or making a finger motion may alter the motion of the plurality of objects 104 during calibration. Depressing an “enter” key or a “Pop-In” or “Pop-Out” selection key may be used to identify a preferred maximum range parameter. Input 103 may also comprise “observational inputs” such as a camera or other device which monitors the user's behavior, such as characteristics of the user's eye, in response to particular calibration stimuli.

Database storage 106, though depicted outside device 105 may comprise means for storing data, such as an internal or external storage to device 105 wherein the user's preferences may be stored. In some embodiments, database 106 may comprise a portion of device 105's internal memory. In some embodiments, database 106 may comprise a central server system external to device 105. The server system may be accessible to multiple display devices so that the preferences determined on one device are available to another device.

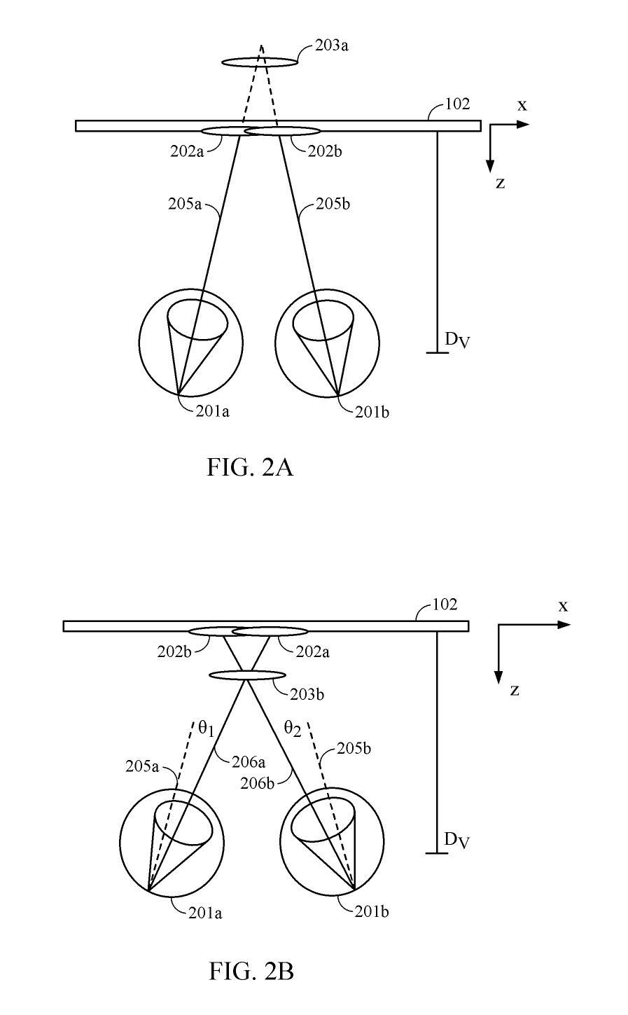

As mentioned, when depicting a stereoscopic scene, device 105 may present objects 104 to the user as moving in any of the directions x, y, z. Movement in the z direction may be accomplished via the stereoscopic effect. FIG. 2A depicts an object at a negative perceived z-position 203a, i.e. behind display 102 relative to the user. Such a depiction may be accomplished by presenting the object in a first position 202a in a first image and at a second position 202b in a second image. When the user's left eye 201a perceives the first image and the user's right eye 201b perceives the second image, the user's brain may integrate the images to perceive the object at perceived position 203a. There may be a “safe area” band around the display in which fusion happens without eye strain. This band may change in response to the user's distance Dv relative to the display 102, based at least in part on factors described below. In some systems the images may be previously captured using two, separate, real-world physical cameras. In some systems the images may be dynamically generated by software which employs “virtual cameras” to determine the appropriate image of the scene. A virtual camera may comprise a point of view in a synthetically generated environment or scene.

Conversely, as shown in FIG. 2B, when the positions 202b and 202a are reversed in each image, the user's brain may integrate the images to perceive the object as being at perceived position 203b. In this manner, objects may appear in positive or negative z-direction locations relative to the plane of display 102.

Different users' brains may integrate object disparity between the images of FIGS. 2A and 2B with different degrees of comfort. The user's ability to comfortably perceive the stereoscopic effect may depend both upon the lateral disparity of positions 202a and 202b as well as upon the angular disparity associated with the positions. Lateral disparity refers to the offset in the x-direction between each of positions 202a and 202b. Typically, an offset in the y direction will not be present, although this may occur in some display systems. Angular disparity refers to the rotation of each eye that occurs when perceiving an object at each of perceived positions 201a-b. With reference to the example of FIGS. 2A and 2B, lines 205a and 205b refer to the centerline for each of eyes 201a, 201b when viewing an object at perceived position 203a in FIG. 2A (a centerline refers to the center of the scene as viewed by the eye). When the eyes instead view the perceived object at position 203b in FIG. 2B, the eyes rotate towards one another until their centerlines approach 206a and 206b. A difference in angle θ₁ and θ₂ results between the centerlines 205a, 206a and 205b, 206b respectively. These angle differences θ₁ and θ₂ comprise the angular disparity resulting from the perception of the object at a particular perceived location. In some instances, the user's comfort may depend both upon the lateral and angular disparity. Some users may be more affected by angular disparity and some users may be more affected by lateral disparity. Acceptable disparities for one user may be uncomfortable or even painful for another. By modifying the output of display 102, so as not to present disparities outside a user's comfort zone, user discomfort may be mitigated or avoided entirely.

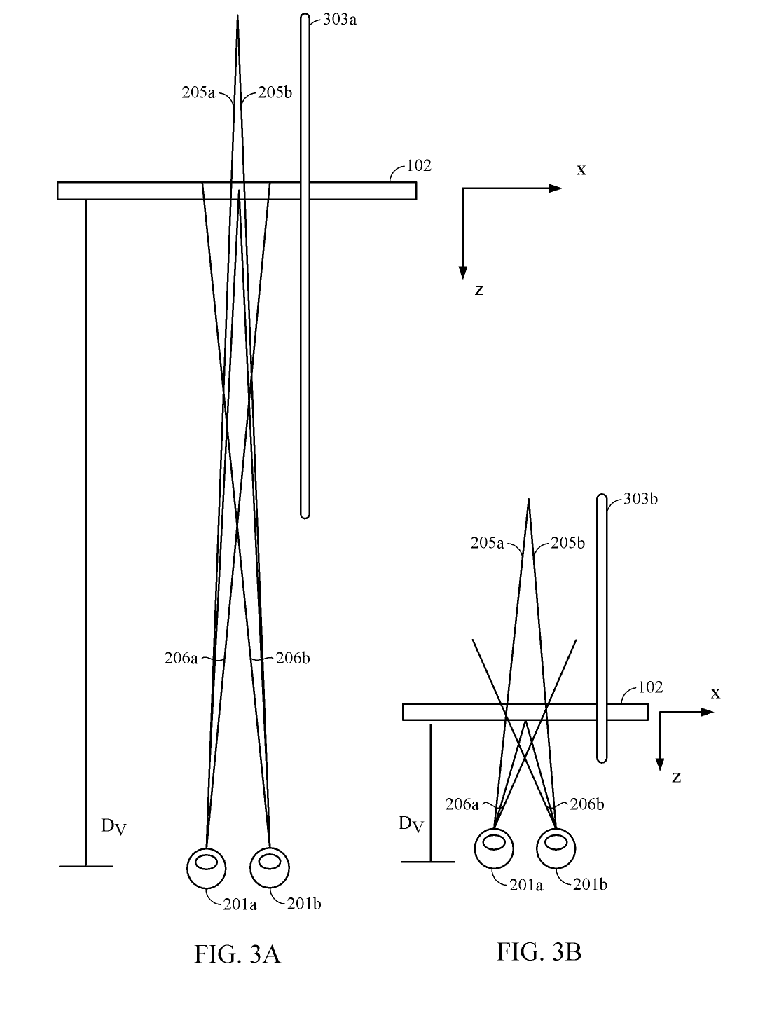

Unfortunately, in some circumstances cataloguing a user's lateral and angular disparity preferences in isolation from other factors may not suffice to avoid user discomfort. Lateral and angular disparities may interrelate with one another, and with other factors, holistically when a user perceives the stereoscopic effect. For example, with reference to FIGS. 3A and 3B, the user's location relative to the display 102 may likewise affect the user's preferences. A user viewing display 102 from a far location (large Dv, FIG. 3A) and a near location (small Dv, FIG. 3B) may experience different degrees of discomfort, even though the same lateral disparity is presented in both instances. The discomfort may be correlated instead with the angular disparity, since a user's distance from the display 102 will affect the angular disparity even when the lateral disparity remains constant. As illustrated, centerlines corresponding to the perception of objects with negative 205a, 205b and positive 206a, 206b depth when the user views display 201 vary with Dv. Display 102's screen dimensions may also affect the range of angular disparity acceptable to the user. At a fixed distance from the screen, a larger screen dimension will present a larger field of view. This is similar to a zoom in effect (the tolerable pixel disparity may be less). Conversely, for the same field of view, a user would probably prefer less pop out for a smaller distance to the screen. Thus, even if a user experiences the same lateral disparity for both positions of FIGS. 3A and 3B, they may prefer the z-direction range 303a when far from screen 102, and range 303b when near display 102, as a consequence of the angular disparity. Furthermore, as illustrated by ranges 303a and 303b, user preferences may not be symmetric about the display screen 102. For example, some users tolerate negative depth better than positive depth and vice versa.

Certain of the present embodiments contemplate displaying an interactive stereoscopic video sequence to the user and receiving input from the user to determine the user's preferred ranges of the stereoscopic effect. The interactive video sequence may be especially configured to determine the user's lateral and angular disparity preferences at a given distance from display 102. In some embodiments, the user may specify their distance from display 102 in advance. In other embodiments, the distance may be determined using a range-finder or similar sensor on device 105. In certain embodiments, the video sequence may comprise moving objects that appear before and behind the plane of the display (i.e., in positive and negative positions in the z-direction). As the user perceives the objects' motion, the user may indicate positive and negative depths at which they feel comfort or discomfort. These selections may be translated into the appropriate 3D depth configuration parameter to be sent to the 3D processing algorithm. In some embodiments, a single image depicting a plurality of depths may suffice for determining the user's preferences. In some embodiments, the video may be dynamically generated based upon such factors as the user's previous preferences, data, such as a user location data, derived from other sensors on device 104, and user preferences from other stereoscopic devices (such as devices which have been previously calibrated but possess a different screen geometry). In some embodiments, the video sequence may be generated based on a screen geometry specified by the user. In some embodiments, the screen geometry may be automatically determined.

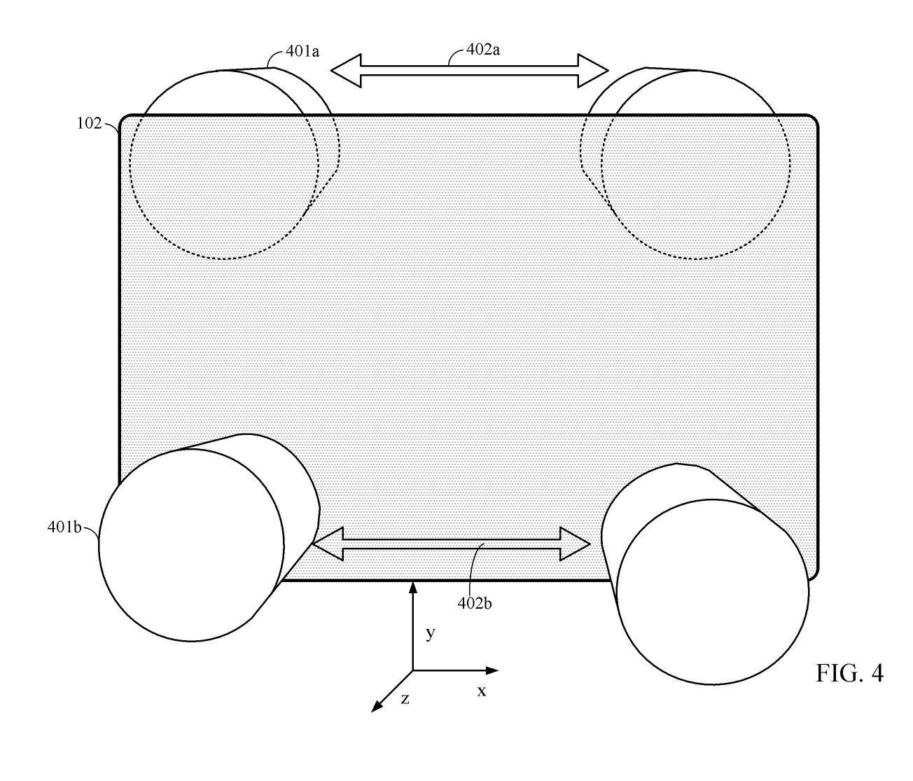

With reference to FIG. 4, in certain embodiments the video sequence may comprise images depicting one or more objects 401a, 401b as they move along patterns 402a, 402b. In some embodiments, certain objects 401a may be located at negative z-positions (behind the screen, or at “pop-in” positions) and other objects 401b may be located at positive z-positions (before the screen, or at “pop-out” positions). The objects 401a, 401b may move along patterns 402a, 402b. Although depicted in FIG. 4 as travelling exclusively in the x-y plane, in some embodiments the patterns may cause the objects to travel in the z-direction as well. In some embodiments, a plurality of objects at different z-positions may be displayed, and each object may move in the x-y plane. Movement within the x-y plane may allow the user to perceive the stereoscopic effect in relation to the screen geometry of the display 102. In some embodiments, this motion may be used to determine the “safe area” band in which the user may fuse the images without straining. In some embodiments, the user may control the objects' movement, possibly using input 103. The user may translate the objects in each of the x, y, and z planes and indicate their preferences at certain of the locations using input 103. For example, the user may make finger gestures or depress channel or volume selection keys to move the objects 401b. When moving the object the user may indicate their tolerance to depth movement (i.e. the effect of different rate and disparity values).

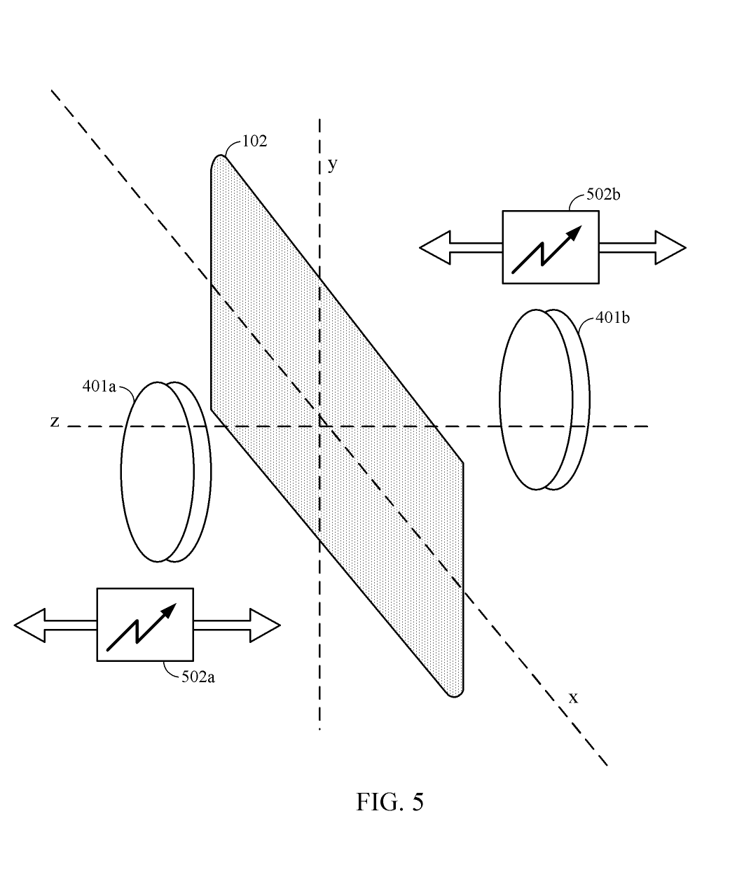

FIG. 5 depicts the motion of objects 401a and 401b in certain embodiments in the z-direction. The user may provide selection ranges 502a, 502b for positive and negative depths respectively. As mentioned, in some embodiments, the user may direct the motion of the objects 401a, 401b possibly via input 103. Thus, the user may direct objects along various patterns 402a, 402b and may indicate their comfort with regard to the stereoscopic effect at certain locations. In some embodiments, the device 105 may determine the locations at which the user provides input prior to displaying the sequence. In some embodiments, the user may determine the locations at which input is provided.

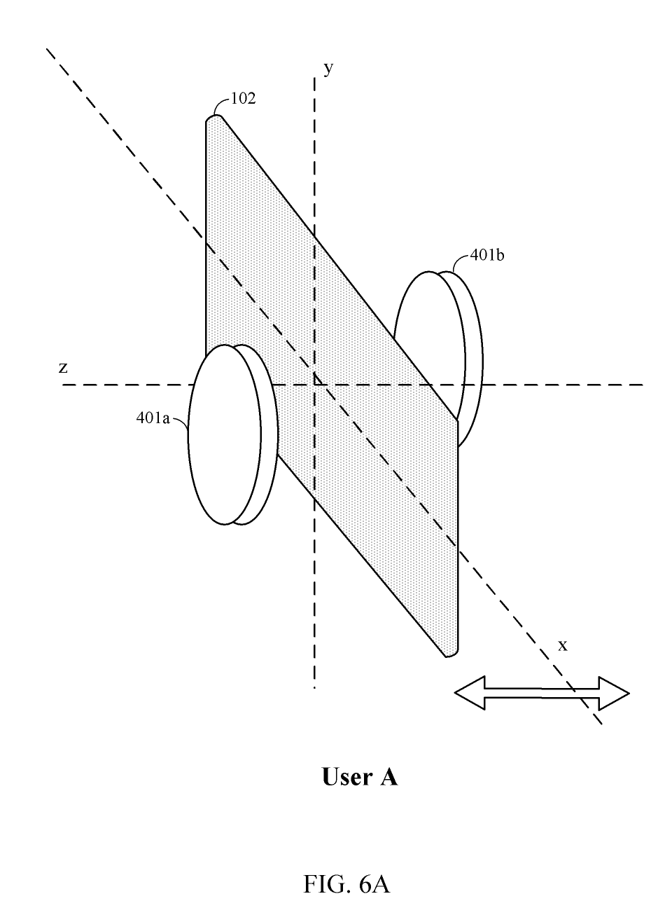

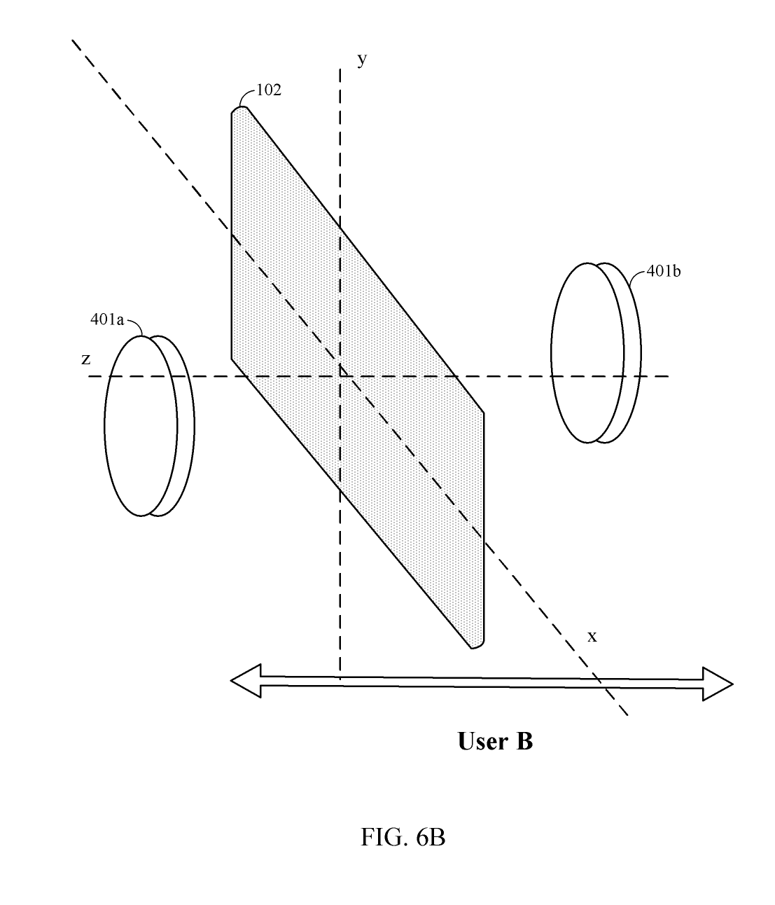

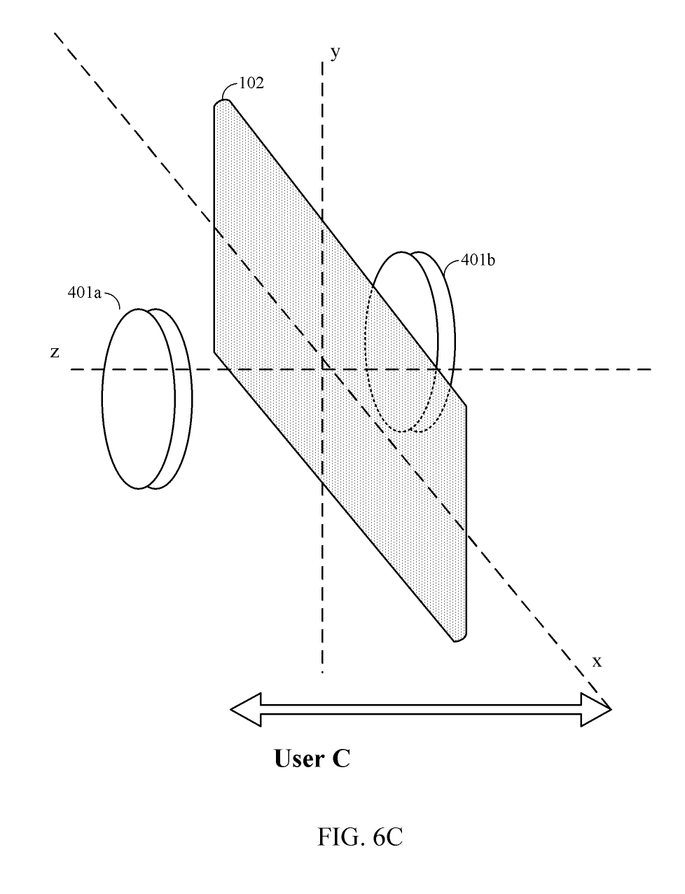

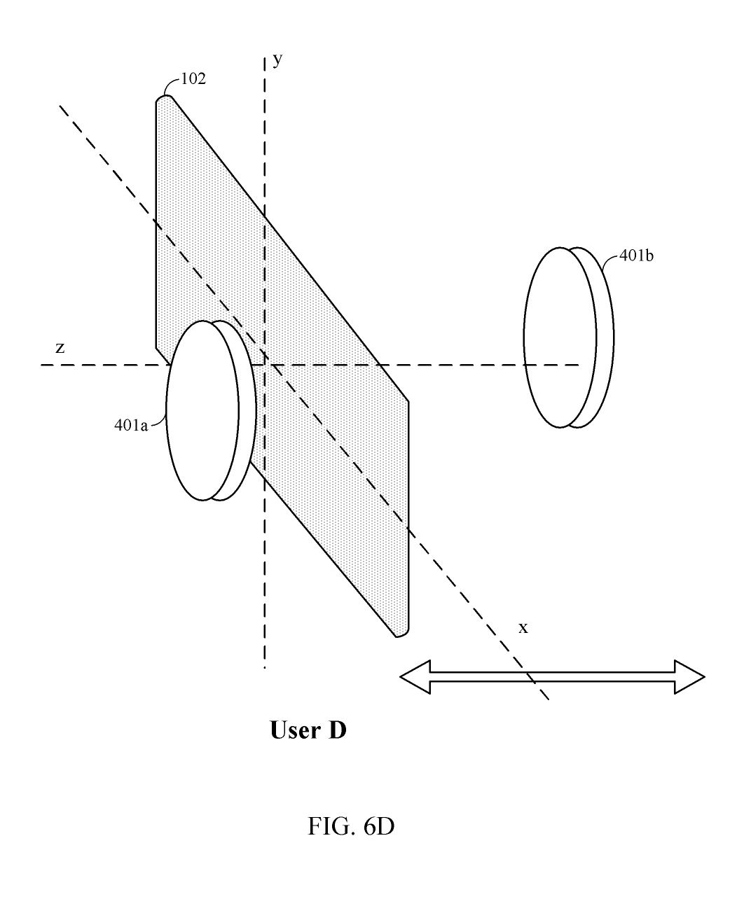

FIGS. 6A-6D depict certain of the user-preferred ranges for four different users. In FIG. 6A the user prefers only a small amount of positive depth while preferring greater negative depth. Accordingly, the user may have expressed a favorable indication at the positions for objects 401a and 401b shown in FIG. 6A. In FIG. 6B, the user prefers both substantial positive and negative depth. Appropriate preference indications may have similarly been specified at the indicated object positions. In FIG. 6C the user prefers a slight amount of both positive and negative depth. In FIG. 6D the user prefers only negative depth with no positive depth.

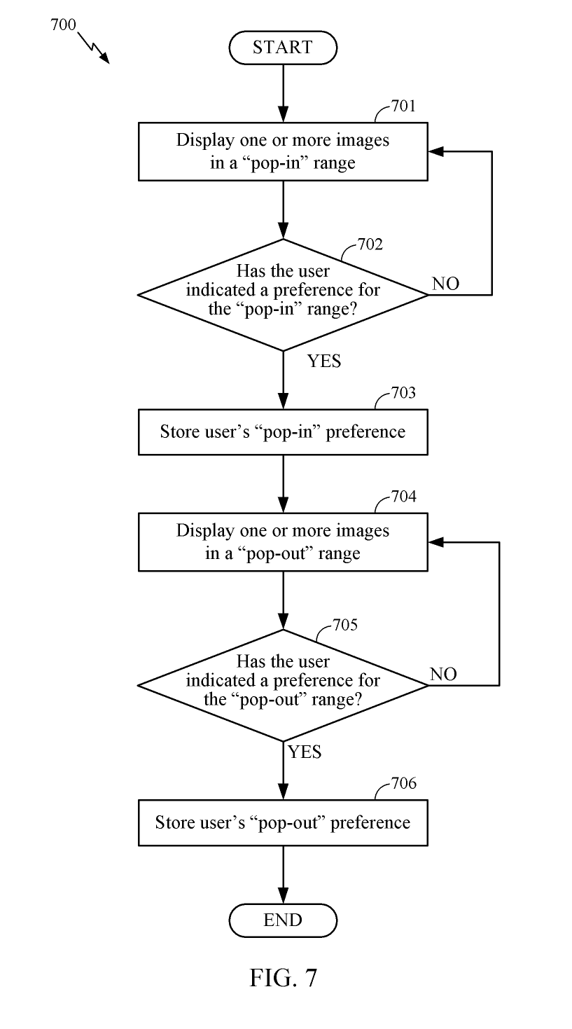

FIG. 7 is a flow diagram depicting the preference determination algorithm employed by certain of the embodiments. The process 700 begins by displaying one or more images, such as in a video sequence, of an object at a plurality of “pop-in” or negative z-position at block 701. The process 700 may then determine at decision block 702 if the user has indicated a preference for the pop-in range. One may recognize a plurality of ways to receive a preference indication, such as to wait for an interrupt originating from the input device 103. The interrupt may be generated in response to the user depressing a key or making a gesture. Alternatively, the system may monitor the user via a sensor and determine the user's preference by observing the user's reaction throughout the video sequence. As discussed above, the preference may be indicated for a plurality of locations in the x-y plane. After receiving the user's preference for the “pop-in” or negative z-position, the process 700 may then store the preferences for future reference at block 703. The system may then determine the preferences for the “pop-out” or positive z-direction at block 704. Again, once the user indicates a preference at block 705, the “pop-out” preference may be stored at block 706. One may readily envision variations of the above wherein the user also indicates the preferred x and y ranges, such as may comprise the “safe area” band. The preferences may be stored to database 106.

One skilled in the art will recognize that once the maximum pop-in and pop-out ranges are determined, numerous corresponding values may be stored in lieu of the actual ranges. Thus, in some embodiments, the stored preferences or parameters may comprise the values of the preferred pop-in and pop-out ranges (i.e., the maximum pop-in value and the maximum pop-out value). However, in other embodiments the corresponding disparity ranges for objects appearing in each image may instead be stored. In some embodiments, the position and orientation of the virtual cameras used to generate the images which correspond to the user's preferred ranges may be stored. In this case, the stored preference may be used when dynamically generating a subsequent scene. As mentioned, database 106 may in some embodiments provide other display devices with access to the user's preferences so that it is unnecessary for the user to recalibrate each system upon use. Software modules configured to store the user preferred ranges, table lookups to associate a preferred range with one or more variables affecting the display of stereoscopic images, software making reference to such a lookup table and other means for determining a parameter based upon a preference indication will be readily recognized by one skilled in the art. Thus, in some instances the determining means may simply identify the user indicated range as a parameter to be stored. Alternatively, the determining means may identify a value for a display variable, such as the disparity, corresponding to the range. The maximum disparity value, rather than the user defined range may then be stored.

Certain of the embodiments, such as the embodiments of FIG. 7, provide rapid feedback between the user and the calibration system. The user can select or indicate the pop-in and pop-out parameters and immediately perceive the effect of their selection or indication upon the display. Where the display depicts a sequence of frames, such as a three-dimensional video, the system may vary the object speed and trajectory throughout the calibration process. In some embodiments, the calibration video may be dynamically adjusted as the user indicates different selections. The system may comprise heuristics to determine how the video should be modified based on one or all of the user's previous preference indications.

One will recognize that the order in which the negative and positive depth preferences are determined may be arbitrary and in some embodiments may occur simultaneously. The video sequence may, for example, simultaneously display pairs of objects at locations in the x, y, and z directions known to comprise extrema for user preferences. By selecting a pair, the user may indicate both a positive and negative depth preference with a single selection. In some instances, it may be necessary to display only a single stereoscopic image.

Once the system has determined a user's preferences the preferences may be stored for use during subsequent displays. Alternatively, some embodiments contemplate converting the preference to one or more display parameters for storage instead. For example, a user preference may be used to determine a maximum scaling factor for positive and negative depth during display. Storing the scaling factors or another representation may be more efficient than storing depth ranges. Additional data, such as data regarding the user's location relative to the display 102, may also be converted into appropriate parameters prior to storage in database 106.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

1. A method, implemented on an electronic device, for determining a parameter for a stereoscopic effect comprising:
displaying to a user a plurality of images comprising a stereoscopic effect of an object, the object depicted at a plurality of three-dimensional locations by the plurality of images;
receiving a preference indication from the user of a preferred three-dimensional location; and
determining a parameter for stereoscopic depictions of additional images based upon the preference indication.

2. The method of claim 1, wherein at least two of the plurality of locations are displaced relative to one another in the x, y, and z directions.

3. The method of claim 1, wherein the plurality of locations comprises a location having a positive depth position.

4. The method of claim 3, wherein the plurality of images further comprise a stereoscopic effect of a second object, the second object depicted at a second plurality of locations by the plurality of images, the second plurality of locations comprising a location having a negative depth position.

5. The method of claim 1, wherein the plurality of images depicts movement of the object in the plane of a display.

6. The method of claim 1, wherein the plurality of images is dynamically generated based on at least a screen geometry of a display.

7. The method of claim 1, wherein the plurality of images is dynamically generated based on at least the user's distance from a display.

8. The method of claim 1, further comprising storing the parameter to a memory.

9. The method of claim 8, further comprising determining a maximum range for depth of the object based upon the parameter.

10. The method of claim 1, wherein the electronic device comprises a mobile phone.

11. The method of claim 1, wherein the parameter is the preference indication.

12. A computer-readable medium comprising instructions that when executed cause a processor to perform the following steps:
displaying to a user a plurality of images comprising a stereoscopic effect of an object, the object depicted at a plurality of locations by the plurality of images;
receiving a preference indication from the user of a preferred three-dimensional location; and
determining a parameter for stereoscopic depictions of additional images based upon the preference indication.

13. The computer-readable medium of claim 12, wherein at least two of the plurality of locations are displaced relative to one another in the x, y, and z directions.

14. The computer-readable medium of claim 12, wherein the plurality of locations comprises a location having a positive depth position.

15. The computer-readable medium of claim 14, wherein the plurality of images further comprise a stereoscopic effect of a second object, the second object depicted at a second plurality of locations by the plurality of images, the second plurality of locations comprising a location having a negative depth position.

16. The computer-readable medium of claim 12, wherein the plurality of images depicts movement of the object in the plane of the display.

17. A electronic stereoscopic vision system, comprising:
a display;
a first module configured to display a plurality of images comprising a stereoscopic effect of an object, the object depicted at a plurality of locations by the plurality of images;
an input configured to receive a preference indication from the user of a preferred three-dimensional location; and
a memory configured to store a parameter associated with the preference indication, wherein the parameter is used to display additional images according to the preference indication of the user.

18. The stereoscopic vision system of claim 17, wherein at least two of the plurality of locations are displaced relative to one another in the x, y, and z directions.

19. The stereoscopic vision system of claim 17, wherein the plurality of locations comprises a location having a positive depth position.

20. The stereoscopic vision system of claim 19, wherein the plurality of images further comprise a stereoscopic effect of a second object, the second object depicted at a second plurality of locations by the plurality of images, the second plurality of locations comprising a location having a negative depth position.

21. The stereoscopic vision system of claim 17, wherein the plurality of images depicts movement of the object in the plane of the display.

22. The stereoscopic vision system of claim 17, wherein the plurality of images is dynamically generated based on at least a screen geometry of the display.

23. The stereoscopic vision system of claim 17, wherein the plurality of images is dynamically generated based on at least the user's distance from the display.

24. The stereoscopic vision system of claim 17, wherein the electronic device comprises a mobile phone.

25. The stereoscopic vision system of claim 17, wherein the parameter is the preference indication.

26. A stereoscopic vision system in an electronic device, the system comprising:
means for displaying to a user a plurality of images comprising a stereoscopic effect of an object, the object depicted at a plurality of locations by the plurality of images;
means for receiving a preference indication from the user of a preferred three-dimensional location; and
means for determining a parameter for stereoscopic depictions of additional images based upon the preference indication.

27. The stereoscopic vision system of claim 26, wherein the displaying means comprises a display, the depicting means comprises a plurality of images, the means for receiving a preference indication comprises an input, and the means for determining a stereoscopic parameter comprises a software module configured to store a preferred range.

28. The stereoscopic vision system of claim 26, wherein at least two of the plurality of locations are displaced relative to one another in the x, y, and z directions.
